(19) United States
(12) Patent Application Publication
(10) Pub. No.: US 2011/0086244 A1
(43) Pub. Date: Apr. 14, 2011

(54) SECONDARY BATTERY

(75) Inventors: Woonseong BAEK, Suwon-si (KR); Heuisang YOON, Suwon-si (KR); Kyungwon SEO, Suwon-si (KR)

(73) Assignee: Samsung SDI CO., LTD., Yongin-si (KR)

(21) Appl. No.: 12/883,372

(22) Filed: Sep. 16, 2010

(30) Foreign Application Priority Data
Oct. 9, 2009 (KR) 10-2009-0096103

(51) Int. Cl. H01M 2/34

(52) U.S. Cl. 429/7

(57) ABSTRACT

A secondary battery that includes a lower case and a label that are securely adhered to each other. The secondary battery includes a bare cell that receives an electrode assembly and having one end to which an electrode terminal is exposed, a protective circuit module electrically connected to the electrode terminal to control charging and discharging, an upper case accommodating the protective circuit module and installed at an upper portion of the bare cell, a hollow label having its top and bottom ends opened, accommodating the bare cell and including a bent portion adhered to the upper case at the top end and bent to extend inward at the bottom end, and a lower case sealing the bottom end of the label.

### CLAIM OF PRIORITY

This application makes reference to, incorporates into this specification the entire contents of, and claims all benefits accruing under 35 U.S.C. §119 from an application earlier filed in the Korean Intellectual Property Office filed on Oct. 9, 2009 and there duly assigned Serial No. 10-2009-0096103.

### BACKGROUND OF THE INVENTION

1. Field of the Invention

The present invention relates to a secondary battery.

2. Description of the Related Art

In general, a secondary battery includes a bare cell receiving an electrode assembly. In order to protect the bare cell against an external impact, a label is wrapped around the bare cell, and a lower case is disposed at a lower portion of the label.

In the manufacture of secondary batteries, a drop test is performed to evaluate battery endurance against an external impact applied to a bare cell. In the tested secondary battery, in a case where a lower case and a label may not be fastened together, the lower case may be liable to be separated from the label.

The above information disclosed in this Related Art section is only for enhancement of understanding of the background of the invention and therefore it may contain information that does not form the prior art that is already known to a person of ordinary skill in the art.

### SUMMARY OF THE INVENTION

It is therefore a feature of the present invention to provide a secondary battery having a lower case and a label securely adhered to each other.

At least one of the above and other features and advantages may be realized by providing a secondary battery including a bare cell receiving an electrode assembly and having one end to which an electrode terminal is exposed, a protective circuit module electrically connected to the electrode terminal to control charging and discharging, an upper case accommodating the protective circuit module and installed at an upper portion of the bare cell, a label having its top and bottom ends opened, accommodating the bare cell and including a bent portion adhered to the upper case at the top end and bent to extend inward at the bottom end, and a lower case sealing the bottom end of the label.

In the secondary battery of the present invention, the lower case can be securely engaged with the label at a lower portion of the label using the bent portion and the through-holes. Therefore, it is possible to prevent the lower case from being separated from the label in the drop test.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 illustrates an exploded perspective view of a secondary battery as an embodiment according to the principles of the present invention;

FIG. 2 illustrates an assembled state of the secondary battery shown in FIG. 1;

FIG. 3A illustrates a front view of a label shown in FIG. 1, and FIG. 3B illustrates a sectional view taken along the line X-X′ of FIG. 1;

FIG. 4 illustrates a front view of a label for a secondary battery as another embodiment according to the principles of the present invention;

FIG. 5 illustrates a sectional view of a label for a secondary battery as still another embodiment according to the principles of the present invention;

FIG. 6 illustrates a perspective view of a label for a secondary battery as still another embodiment according to the principles of the present invention, in which a lower case is formed;

FIG. 7A illustrates a front view of FIG. 6, and FIG. 7B illustrates a sectional view taken along the line Y-Y′ of FIG. 6;

FIG. 8 illustrates a front view of a label for a secondary battery as still another embodiment according to the principles of the present invention;

FIG. 9 illustrates a sectional view of a label for a secondary battery as still another embodiment according to the principles of the present invention;

FIG. 10 illustrates a front view of a label for a secondary battery as still another embodiment according to the principles of the present invention; and

FIG. 11 illustrates a front view of a label for a secondary battery as still another embodiment according to the principles of the present invention.

### DETAILED DESCRIPTION OF THE INVENTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

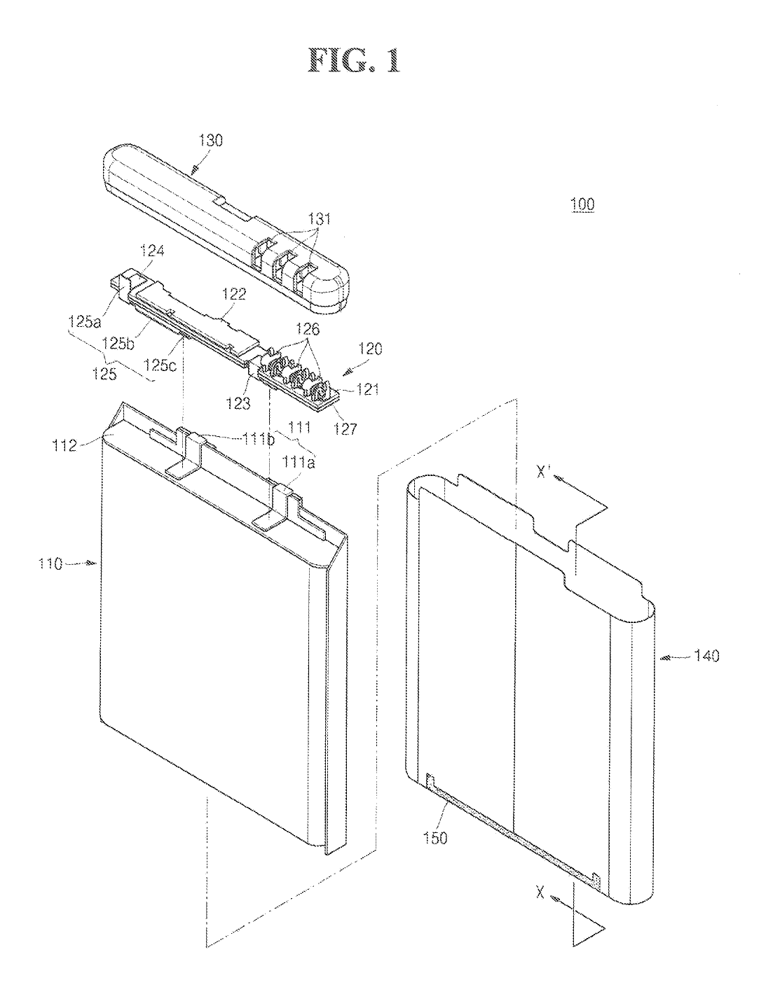

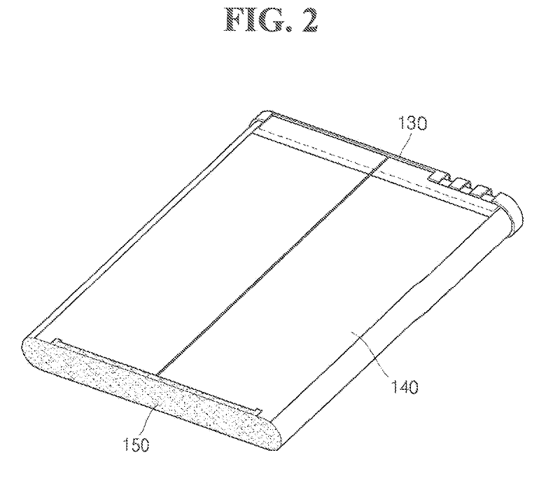

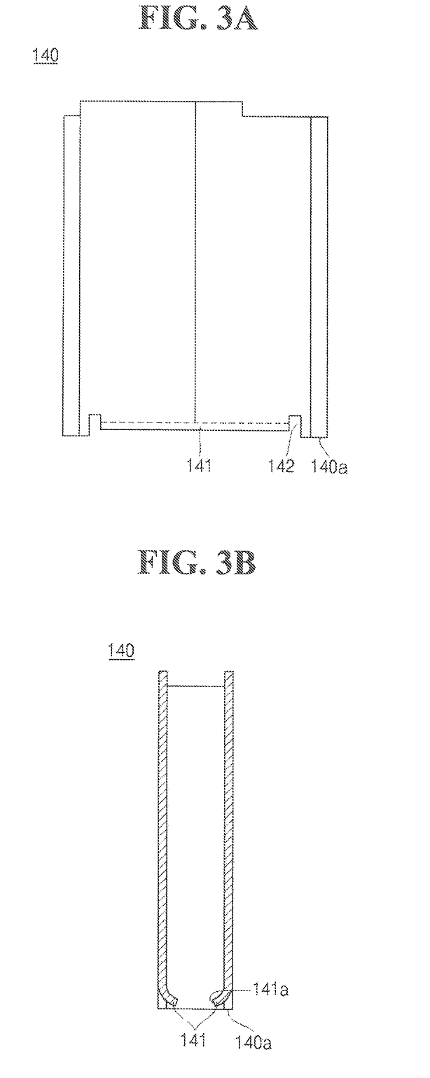

FIG. 1 is an exploded perspective view of a secondary battery as an embodiment according to the principles of the present invention, FIG. 2 illustrates an assembled state of the secondary battery shown in FIG. 1, FIG. 3A illustrates a front view of a label shown in FIG. 1, and FIG. 3B illustrates a sectional view taken along the line X-X′ of FIG. 1.

Referring to FIGS. 1 to 3B, the secondary battery 100 as an embodiment according to the principles of the present invention includes a bare cell 110, a protective circuit module 120, an upper case 130, a label 140, and a lower case 150.

The bare cell 110 includes an electrode assembly (not shown), an electrode terminal 111 and a first insulation tape 112. The bare cell 110 may be a pouch-type bare cell.

The electrode assembly includes a positive electrode plate, a separator and a negative electrode plate sequentially stacked and is wound in a jelly-roll configuration to then be received inside the bare cell 110.

The electrode terminal 111 includes a first electrode terminal 111a and a second electrode terminal 111b.

The first electrode terminal 111a is exposed at a first end of the bare cell 110. The first electrode terminal 111a is bent along one surface of the bare cell 110. The first electrode terminal 111a is electrically connected to the positive electrode plate or the negative electrode plate and may function as a negative electrode or a positive electrode.

The second electrode terminal 111b is also exposed at a first end of the bare cell 110. In addition, the second electrode terminal 111b is bent along the first surface of the bare cell 110. The second electrode terminal 111b is electrically connected to the positive electrode plate or the negative electrode plate and has polarity opposite to the first electrode terminal 111a.

The first insulation tape 112 is positioned between the first surface of the bare cell 110 and a bottom surface of the first electrode terminal 111a and the second electrode terminal 111b. The first insulation tape 112, which is a double sided tape, allows the bent first and second electrode terminals 111a and 111b, which are bent along the first surface of the bare cell 110, to be more tightly adhered to the first surface of the bare cell 110.

A protective circuit module 120 includes a board 121, a protection circuit 122, a lead plate 123, a tab 124, a fuse 125, external terminals 126, and a second insulation tape 127.

The board 121 includes the protection circuit 122, the lead plate 123, the tab 124, the fuse 125, and the external terminals 126 electrically connected thereon.

The protection circuit 122, which is formed in the board 121, includes charge/discharge control devices and switching devices, and protects the secondary battery 100 through open-circuiting when overcharging or overdischarging occurs.

The lead plate 123 is electrically connected to an external device (not shown) on a top surface of the board 121 to then bent toward a bottom surface of the board 121 along one side surface of the board 121. The lead plate 123 is also electrically connected to the first electrode terminal 111a.

The tab 124 extends from the board 121 upward. One side of the tab 124 is electrically connected to the fuse 125.

The fuse 125 includes a first lead 125a, a main body 125b and a second lead 125c.

The first lead 125a extends from one end of the main body 125b to be electrically connected to the tab 124.

The main body 125b senses a heat of the bare cell 110 and is electrically disconnected when the temperature of the bare cell 110 exceeds a predetermined level.

The second lead 125c extends from the other end of the main body 125b to be electrically connected to the second electrode terminal 111b.

The main body 125b and the second lead 125c of the fuse 125 are bent toward the bottom surface of the board 121 along one side surface of the board 121.

The external terminals 126 protrude upward from the board 121 to then be electrically connected to an external device(not shown) during charging or discharging of the secondary battery 100.

The second insulation tape 127 is provided between the bottom surface of the board 121 and the lead plate 123. In addition, the second insulation tape 127 is provided between each of the bottom surface of the board 121, the main body 125b and the second lead 125c. In an assembled state of the secondary battery 100, the second insulation tape 127 electrically insulates the lead plate 123 or the fuse 125 from the bottom surface of the board 121.

The upper case 130 is separately formed by injection molding. The upper case 130 includes a receiving part (not shown) corresponding to the protection circuit 122 and the external terminals 126. The upper case 130 receives the protection circuit 122 and the external terminals 126 to then be assembled with the protective circuit module 120. The upper case 130 also includes openings 131.

When the protective circuit module 120 is coupled to the upper case 130, the external terminals 126 are exposed outside through the openings 131. The label 140 is hollow-shaped to have its top and bottom ends opened and accommodates the bare cell 110. A top end of the label 140 is adhered to the upper case 130. Here, an outer surface of the upper case 130 is adhered to an inner surface of the label 140 by thermal fusion or thermal compression. A heat-seal adhesive, for example, urethane modified silicone, is applied to the inner surface of the label 140 adhered to the outer surface of the upper case 130. The Bare cell 110 and the label 140 are adhered to each other using a heat-seal adhesive.

A bent portion 141 and through-holes 142 are provided at a lower portion of the label 140. The bent portion 141 is bent and extends from the lower portion of the label 140 toward the inside of the label 140. Here, the bent portion 141 extends in an arc shape. In addition, an end 141a of the bent portion 141 is positioned above a bottom end 140a of the label 140. In addition, the bent portion 141 is formed on opposed surfaces of the label 140. The bent portion 141 is accommodated in the lower case 150 to then support the lower case 150. Accordingly, when an external impact is applied to the lower case 150 to the exterior side of the label 140, the label 140 and the lower case 150 retain securely adhered to each other.

The through-holes 142 are formed at a lower portion region of the label 140, the lower portion region corresponding to a potential area where the lower case 150 is to be formed in the label 140. The through-holes 142 are formed at both sides of the bent portion 141. The through-holes 142 allow a resin used to form the lower case 150 to easily move into the label 140 during insert injecting or hot melting.

The lower case 150 is formed at a lower portion of the label 140. The lower case 150 accommodates the bent portion 141 and seals the bottom end of the label 140. The lower case 150 is formed by insert injecting or hot melting.

Hereinafter, a secondary battery as another embodiment according to the principles of the present invention will be described with reference to the accompanying drawings.

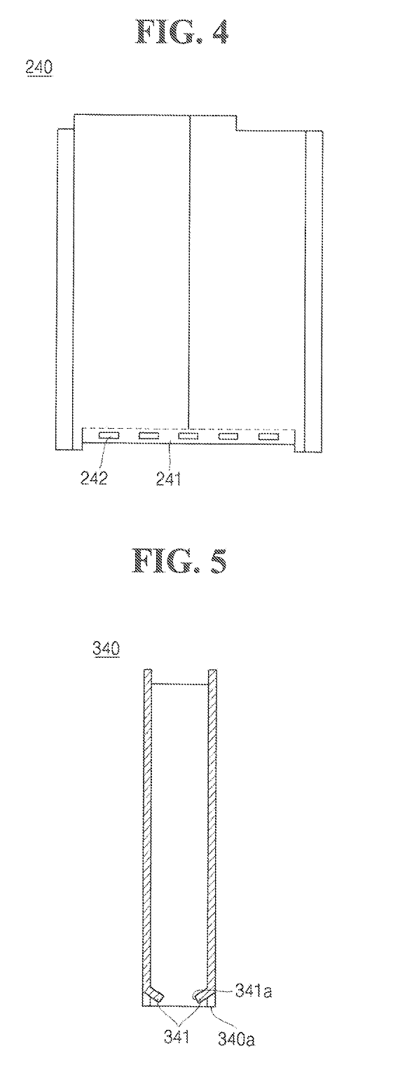

FIG. 4 illustrates a front view of a label for a secondary battery as another embodiment according to the principles of the present invention.

The secondary battery according to the illustrated embodiment is substantially the same as that according to the previous embodiment illustrated in FIGS. 1 to 3B, except for the configuration of a label 240. Thus, the illustrated embodiment that follows will be described in detail with regard to the label 240 and a lower case provided at a lower portion of the label 240, and for brevity of explanation, FIG. 4 illustrates only the label 240. Since the other components have substantially the same configurations and operations with the same or corresponding components of the embodiment illustrated with reference to FIGS. 1 to 3B, a duplicated explanation will be omitted and only the difference will be described in details.

Referring to FIG. 4, the secondary battery according to the illustrated embodiment includes through-holes 242 formed in an interior region of a bent portion 241.

The through-holes 242 allow a resin used to form the lower case to easily move into the label 240 during insert injecting or hot melting.

Hereinafter, a secondary battery as still another embodiment according to the principles of the present invention will be described with reference to the accompanying drawings.

FIG. 5 illustrates a sectional view of a label for a secondary battery as still another embodiment according to the principles of the present invention.

The secondary battery according to the illustrated embodiment is substantially the same as that according to the previous embodiment illustrated in FIGS. 1 to 3B, except for the configuration of a label 340. Thus, the illustrated embodiment will now be described in detail with regard to the label 340 and a lower case provided at a lower portion of the label 340, and for brevity of explanation, FIG. 5 illustrates only the label 340. Since the other components have substantially the same configurations and operations with the same or corresponding components of the embodiment illustrated with reference to FIGS. 1 to 3B, a duplicated explanation will be omitted and only the difference will be described in details.

Referring to FIG. 5, the secondary battery according to the illustrated embodiment includes a bent portion 341 formed in a line shape at an angle. Accordingly, it is relatively easy to form the bent portion 341, compared to the bent portion 141 formed in an arc shape, as shown in FIG. 3B. In addition, an end 341a of the bent portion is positioned above a bottom end 340a of the label 340.

Hereinafter, a secondary battery as still another embodiment according to the principles of the present invention will be described with reference to the accompanying drawings.

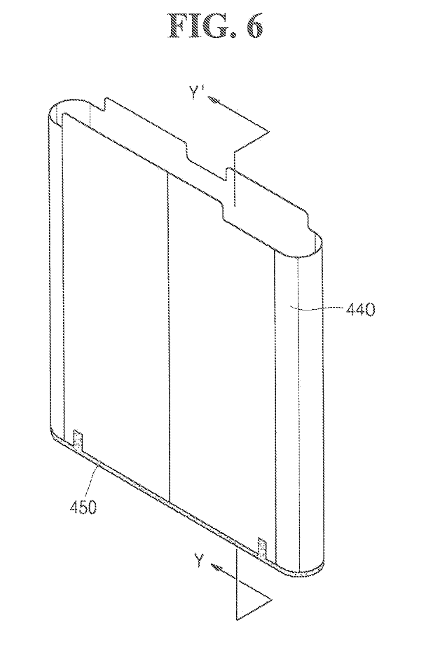

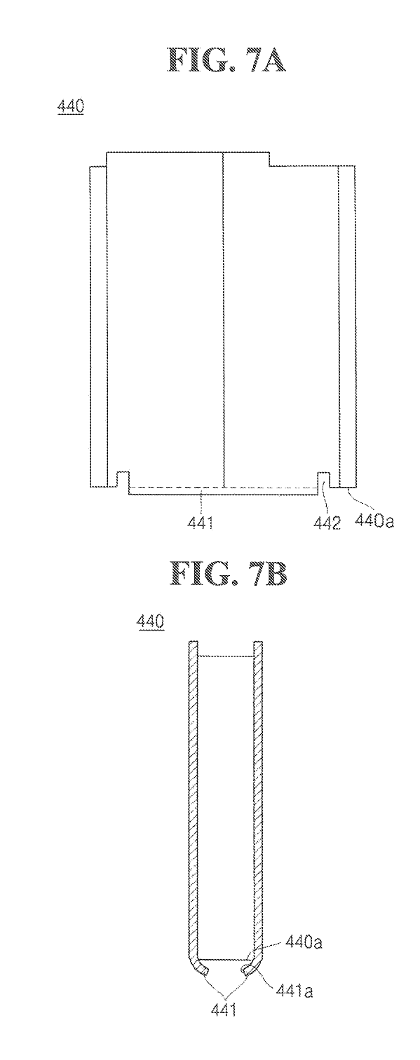

FIG. 6 illustrates a perspective view of a label for a secondary battery as still another embodiment according to the principles of the present invention, in which a lower case is formed, FIG. 7A illustrates a front view of FIG. 6, and FIG. 7B illustrates a sectional view taken along the line Y-Y′ of FIG. 6.

The secondary battery according to the illustrated embodiment is substantially the same as that according to the previous embodiment illustrated in FIGS. 1 to 3B, except for the configuration of a label 440. Thus, the illustrated embodiment will now be described in detail with regard to the label 440 and a lower case 450 provided at a lower portion of the label 440, and for brevity of explanation, FIGS. 6 to 7B illustrate only the label 440 and the lower case 450. Since the other components have substantially the same configurations and operations with the same or corresponding components of the embodiment illustrated with reference to FIGS. 1 to 3B, a duplicated explanation will be omitted and only the difference will be described in details.

Referring to FIGS. 6 to 7B, the secondary battery according to the illustrated embodiment includes a bent portion 441 and through-holes 442 formed at a lower portion of the label 440.

The bent portion 441 extends inward with respect to the label 440 at the lower portion of label 440. Here, the bent portion 441 extends in an arc shape. An end 441a of the bent portion 441 is positioned below a bottom end 440a of the label 440.

The bent portion 441 is formed on opposed surfaces of the label 440. The bent portion 441 is accommodated in the lower case 450 to then support the lower case 450. Accordingly, when an external impact is applied to the lower case 450 from the exterior side of the label 440, the label 440 and the lower case 450 retain securely adhered to each other.

The through-holes 442 are formed such that they extend upward from both sides of the bent portion 441. The through-holes 442 allow a resin used to form the lower case to easily move into the label during insert injecting or hot melting.

The lower case 450 is formed at a lower portion of the label 440. The lower case 450 accommodates the bent portion 441 to then seal a bottom end of the label 440. The lower case 450 is formed by insert injecting or hot melting.

Since end 441a of the bent portion 441 is positioned below bottom end 440a of the label 440, the lower case 450 encloses bottom end 440a of the label 440, thereby preventing bottom end 440a of the label 440 from being damaged against an external impact.

Hereinafter, a secondary battery as still another embodiment according to the principles of the present invention will be described with reference to the accompanying drawings.

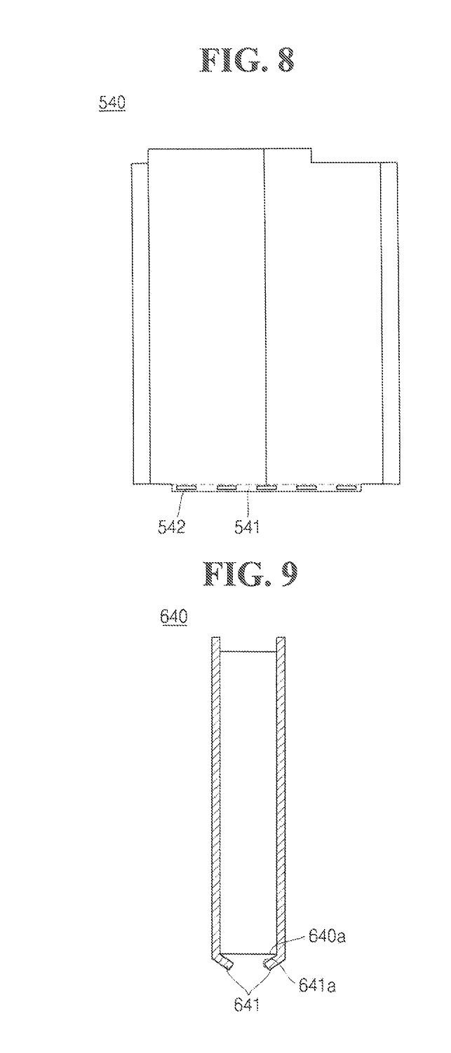

FIG. 8 illustrates a front view of a label for a secondary battery as still another embodiment according to the principles of the present invention. The secondary battery according to the illustrated embodiment is substantially the same as that according to the previous embodiment illustrated in FIGS. 6 to 7B, except for the configuration of a label 540. Thus, the illustrated embodiment will now be described in detail with regard to the label 540, and for brevity of explanation, FIG. 8 illustrates only the label 540. Since the other components have substantially the same configurations and operations with the same or corresponding components of the embodiment illustrated with reference to FIGS. 6 to 7B, a duplicated explanation will be omitted and only the difference will be described in details.

Referring to FIG. 8, the secondary battery according to the illustrated embodiment includes through-holes 542 formed at an interior region of a bent portion 541.

The through-holes 542 allow a resin used to form a lower case to easily move into the label 540 during insert injecting or hot melting. The through-holes 542 allow the resin used to form the lower case to easily move into the label during insert injecting or hot melting. In addition, since resins at opposite sides of the bent portion 541 are combined with each other by the through-holes 542, the lower case can be more securely adhered to a lower portion of the label 540.

Hereinafter, a secondary battery as still another embodiment according to the principles of the present invention will be described with reference to the accompanying drawings.

FIG. 9 illustrates a sectional view of a label for a secondary battery as still another embodiment according to the principles of the present invention. The secondary battery according to the illustrated embodiment is substantially the same as that according to the previous embodiment illustrated in FIGS. 6 to 7B, except for the configuration of a label 640. Thus, the illustrated embodiment will now be described in detail with regard to the label 640, and for brevity of explanation, FIG. 9 illustrates only the label 640. Since the other components have substantially the same configurations and operations with the same or corresponding components of the embodiment illustrated with reference to FIGS. 6 to 7B, a duplicated explanation will be omitted and only the difference will be described in details.

Referring to FIG. 9, the secondary battery according to the illustrated embodiment includes a bent portion 641 extending in a line shape at an angle. Further, an end 641a of the bent portion 641 is positioned below a bottom end 640a of the label 640.

Accordingly, it is relatively easy to form the bent portion 641, compared to the bent portion 441 formed in an arc shape, as shown in FIG. 7B.

Hereinafter, a secondary battery as still another embodiment according to the principles of the present invention will be described with reference to the accompanying drawings.

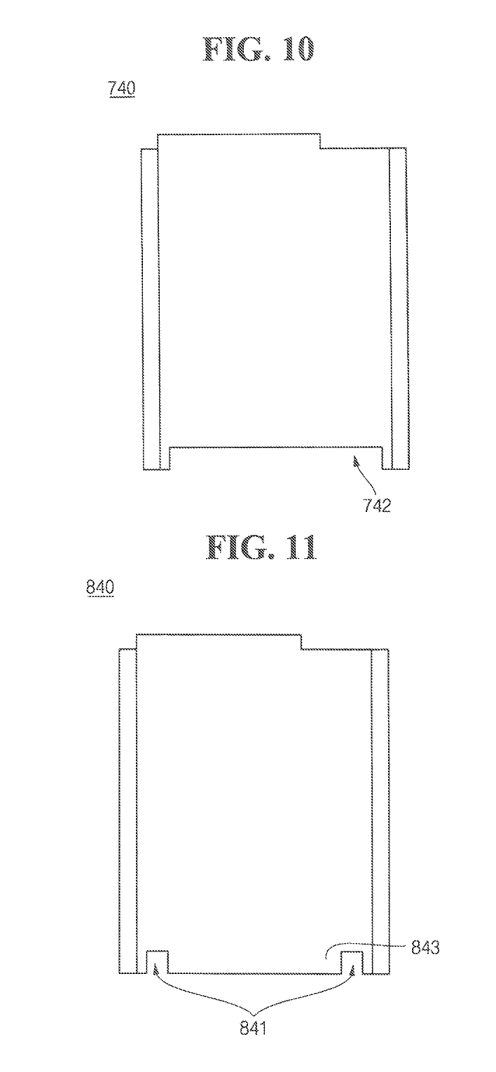

FIG. 10 illustrates a front view of a label for a secondary battery as still another embodiment according to the principles of the present invention. The secondary battery according to the illustrated embodiment is substantially the same as that according to the previous embodiment illustrated in FIGS. 1 to 3B, except for the configuration of a label 740. Thus, the illustrated embodiment will now be described in detail with regard to the label 740, and for brevity of explanation, FIG. 10 illustrates only the label 740. Since the other components have substantially the same configurations and operations with the same or corresponding components of the embodiment illustrated with reference to FIGS. 1 to 3B, a duplicated explanation will be omitted and only the difference will be described in details.

Referring to FIG. 10, the secondary battery according to the illustrated embodiment includes a through-hole 742. formed at a lower portion of the label 740. In the course of assembling the secondary battery, a lower portion of a bare cell is exposed outside by the through-hole 742 and a lower case is then formed. Thus, the lower case can be adhered to the bare cell in a more secured manner by adhering lateral surfaces of the bare cell.

Hereinafter, a secondary battery as still another embodiment according to the principles of the present invention will be described with reference to the accompanying drawings.

FIG. 11 illustrates a front view of a label for a secondary battery as still another embodiment according to the principles of the present invention. The secondary battery according to the illustrated embodiment is substantially the same as that according to the previous embodiment illustrated in FIGS. 1 to 3B, except for the configuration of a label 840. Thus, the illustrated embodiment will now be described in detail with regard to the label 840, and for brevity of explanation, FIG. 11 illustrates only the label 840. Since the other components have substantially the same configurations and operations with the same or corresponding components of the embodiment illustrated with reference to FIGS. 1 to 3B, a duplicated explanation will be omitted and only the difference will be described in details.

Referring to FIG. 11, the secondary battery according to the illustrated embodiment further includes an extension part 843 extending on through-holes 841 to be spaced apart from both sides of the through-holes 841 and to be parallel with a top end of the label 840. An inner surface of the top end of the extension part 843 is adhered to the bare cell by thermal fusion or thermal compression. A lower case is adhered to lateral surfaces of the bare cell by the through-holes 841. Thus, the lower case can be adhered to the bare cell in a more secured manner.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery, comprising:
a bare cell receiving an electrode assembly and having an upper portion and a lower portion in which an electrode terminal is exposed at the upper end;
a protective circuit module electrically connected to the electrode terminal to control charging and discharging;
an upper case accommodating the protective circuit module and installed at the upper portion of the bare cell;
a label having a top end and a bottom end that are open to accommodate the bare cell, the label is adhered to the upper case at the top end, said label includes a bent portion bent that extends inward at the bottom end; and
a lower case sealing the bottom end of the label.

2. The secondary battery of claim 1, wherein the bent portion extends in a line shape at an angle.

3. The secondary battery of claim 1, wherein the bent portion extends in an arc shape.

4. The secondary battery of claim 1, wherein an end of the bent portion is positioned above the bottom end of the label.

5. The secondary battery of claim 1, wherein the bent portion is formed on opposed surfaces of the label.

6. The secondary battery of claim 1, wherein through-holes are formed at a lower portion of the label, the lower portion of the label corresponding to a potential area where the lower case is to be formed in the label.

7. The secondary battery of claim 6, wherein the through-holes are formed at both sides of the bent portion.

8. The secondary battery of claim 6, wherein the through-holes are formed in an interior region of the bent portion.

9. The secondary battery of claim 1, wherein an end of the bent portion is positioned below the bottom end of the label.

10. The secondary battery of claim 9, wherein the bent portion is formed on opposed surfaces of the label.

11. The secondary battery of claim 9, wherein the through-holes are formed at a lower portion of the label, the lower portion of the label corresponding to a potential area where the lower case is to be formed in the label.

12. The secondary battery of claim 11, wherein the through-holes are formed such that they extend upward from both sides of the bent portion.

13. The secondary battery of claim 11, wherein the through-holes are formed in an interior region of the bent portion.

14. The secondary battery of claim 1, wherein the lower case is formed by insert injecting or hot melting.

15. The secondary battery of claim 1, wherein an outer surface of the upper case is adhered to an inner surface of the label.

16. The secondary battery of claim 15, wherein an outer surface of the upper case is adhered to an inner surface of the label by thermal fusion or thermal compression.

17. The secondary battery of claim 16, wherein a heat-seal adhesive is applied to the inner surface of the label adhered to the outer surface of the upper case.

18. The secondary battery of claim 1, wherein an outer surface of the bare cell is adhered to an inner surface of the label by thermal fusion or thermal compression.

19. The secondary battery of claim 18, wherein a heat-seal adhesive is applied to the inner surface of the label adhered to the outer surface of the bare cell.

20. A secondary battery, comprising:
a bare cell to receive an electrode assembly, said bare cell having an upper portion and a lower portion in which an electrode terminal is exposed from said upper portion;
a protective circuit module electrically connected to the electrode terminal to control charging and discharging;
an upper case accommodating the protective circuit odule and installed at the upper portion of the bare cell;
a label being hollow and having a top end and a bottom end that are open to accommodate the bare cell, said top end is adhered to the upper case at the top end, and said label includes a bent portion having at least two ends that are bent to extend inward toward each other at the bottom end; and
a lower case sealing the bottom end of the label,
wherein said bottom end of the label includes a plurality of through holes allowing the entry of a resin,
wherein each of the at least two ends of the bent portion is bent in an arc shape or at a sharp angle toward each other to secure the label to the bare cell.
